(19) United States
(12) Patent Application Publication
(10) Pub. No.: US 2002/0192067 A1
(43) Pub. Date: Dec. 19, 2002

(54) High-precision transfer apparatus for depositing a part on an immobilised pallet

(76) Inventors: Jacques Prodel, Carlepont (FR); Annick Prodel, Carlepont (FR)

Correspondence Address: CHRISTIE, PARKER & HALE, LLP, 350 WEST COLORADO BOULEVARD, SUITE 500, PASADENA, CA, 91105, US

(21) Appl. No.: 10/072,807

(22) Filed: Feb. 7, 2002

(30) Foreign Application Priority Data
Feb. 9, 2001 (FR) 01 01800

(51) Int. Cl. B65G 57/03

(52) U.S. Cl. 414/799

(57) ABSTRACT

An apparatus (14) for the transfer of at least one part (38) to be deposited on an immobilised pallet (12) comprises a transporter (42) equipped with a gripping device (50) and adapted to grasp the part (38) on a distributor (40), displace it and deposit it in a positioning tool (54), and a manipulator (60) equipped with a gripper (62) and adapted to grasp the part in a precise position in the positioning tool (54), displace it and deposit it in a precise position in a positioning receptacle (64) carried by the pallet (12).

The invention relates to the transfer of parts on to pallets.

It more particularly concerns a high-precision transfer apparatus for depositing a part on an immobilised pallet.

Such a transfer apparatus is intended more particularly to form part of an installation for the circulation of part-carrying pallets which are displaced in modules by particular drive means. Such installations which are also referred to as ‘flexible workshops’ comprise modules which can accommodate working stations and/or offer pure circulation functions. Thus, a pallet can be displaced between different working stations in order to effect a succession of operations, for example assembly and/or machining operations, on the parts which are carried by the pallets.

In some cases it is necessary to provide means for transferring a part, with a high degree of precision, on to a pallet which is immobilised at the location of a working station.

That may the case in particular when the situation involves assembling a part, for example a component or element of a product, to another component or element of that product, which is already carried by the pallet.

The design and full implementation of such transfer apparatuses encounter numerous difficulties in a practical context as it is necessary to deposit the part, with a high degree of precision, on the pallet which is itself immobilised at a given location in a working station.

It is known for that purpose to use different transfer apparatuses which seek out the part on a distributor, for example a conveyor, to displace it and then move to deposit it on the pallet.

However, as the distributor and the pallet are often at widely spaced locations and in addition at different vertical levels, that necessitates the implementation of particularly complex apparatuses.

The known transfer apparatuses have been capable of operating hitherto only with installations in which the pallets moved at relatively low speeds and relatively low levels of acceleration.

However, with the progress in robotics, the pallets are now being displaced at high speeds, typically several meters per second, and also at high levels of acceleration. Now, the known transfer apparatuses do not make it possible to follow such operating rates.

Consequently one of the objects of the invention is to provide a transfer apparatus which makes it possible to deposit a part with a high degree of precision on an immobilised pallet.

Another object of the invention is to provide such a transfer apparatus which can operate at high rates which are compatible with modern installations for the circulation of part-carrying pallets in which the pallets are displaced at high speeds and high levels of acceleration.

Yet another object of the invention is to provide such a transfer apparatus which can be easily integrated in such an installation for the circulation of part-carrying pallets.

For that purpose the invention proposes an apparatus for transferring at least one part to be deposited on an immobilised pallet, which comprises a transporter equipped with a gripping device and adapted to grasp the part on a distributor, displace it and deposit it in a positioning tool, as well as a manipulator equipped with a gripper and adapted to grasp the part in a precise position in the positioning tool, displace it and deposit it in a precise position in a positioning receptacle carried by the pallet.

Thus, transfer of the part is effected by two successive co-ordinated operations. The part is first transferred from the distributor to the positioning tool by the transporter and then it is transferred from that positioning tool to a positioning receptacle carried by the pallet, by means of the manipulator.

Breaking down the transfer procedure into two successive movements which are respectively implemented by two different means makes it possible to effect faster and more precise transfer of the part than if the transfer procedure were effected by a single displacement means. In addition the transfer procedure is effected much more quickly by virtue of the fact that the respective amplitudes of displacement of the transporter and the manipulator are more limited and are allocated to more restricted regions.

Advantageously, the distributor and the positioning tool are disposed at adjacent vertical levels while the positioning receptacle carried by the pallet is disposed at a vertical level below the vertical level of the positioning tool.

Thus, the transporter effects a displacement of the part in a substantially horizontal zone while the manipulator effects displacement of the part in a substantially vertical zone.

That makes it possible to use a transporter and a manipulator which involve different structures.

In an embodiment of the invention the transporter comprises a mechanism involving crossed movements, which is adapted to provide pilot-control of a carriage in two mutually perpendicular horizontal directions, and the carriage carries a vertical actuator which supports the gripping device.

The gripping device advantageously comprises two movable jaws adapted to be moved towards each other to grasp the part on the distributor and to be moved away from each other to deposit it in the positioning tool. However it is possible to embody the gripping device by other means, for example in the form of a simple suction cup which picks up the part without any degree of precision.

In a preferred embodiment of the invention the manipulator comprises an actuator involving vertical displacement, which carries a support arm adapted to pivot over a limited angular range of selected value, and the support arm supports the gripper to permit the latter to be displaced by a combined movement of horizontal rotation and vertical translation.

In accordance with another feature of the invention, the manipulator is connected to operational control means for effecting the following sequence of operations: moving the gripper above the positioning tool, actuating the gripper to pick up the part in said positioning tool, pivoting the support arm over said angular range, displacing the support arm vertically without a change to its angular orientation to move the gripper above the positioning receptacle carried by the pallet, actuating the gripper to deposit the part in said positioning receptacle and moving the gripper again above the positioning tool for a fresh sequence of operations.

Advantageously, the gripper comprises two movable jaws adapted to be moved towards each other to grasp the part in the positioning tool and to be moved away from each other to deposit it in the positioning receptacle carried by the pallet.

In accordance with another feature of the invention, the apparatus comprises centering means adapted to effect precise mutual positioning of the gripper on the one hand with the positioning tool and on the other hand with the positioning receptacle carried by the pallet.

The centering means advantageously comprise at least two male centering rods carried by the gripper and adapted to engage either into corresponding holes in the positioning tool or into corresponding holes in the positioning receptacle carried by the pallet.

To facilitate the centering operation the positioning tool is preferably mounted floatingly on a fixed support by way of elastic means.

Likewise the positioning receptacle is advantageously mounted floatingly on the pallet by way of elastic means.

The elastic means may comprise for example elastic washers or legs.

In another aspect the invention concerns an installation for the circulation of part-carrying pallets, which comprises a transfer apparatus as defined hereinbefore, arranged to deposit a part on a pallet at the location of a station of the installation.

In the description set out herein after by way of example reference is made to the accompanying drawings in which:

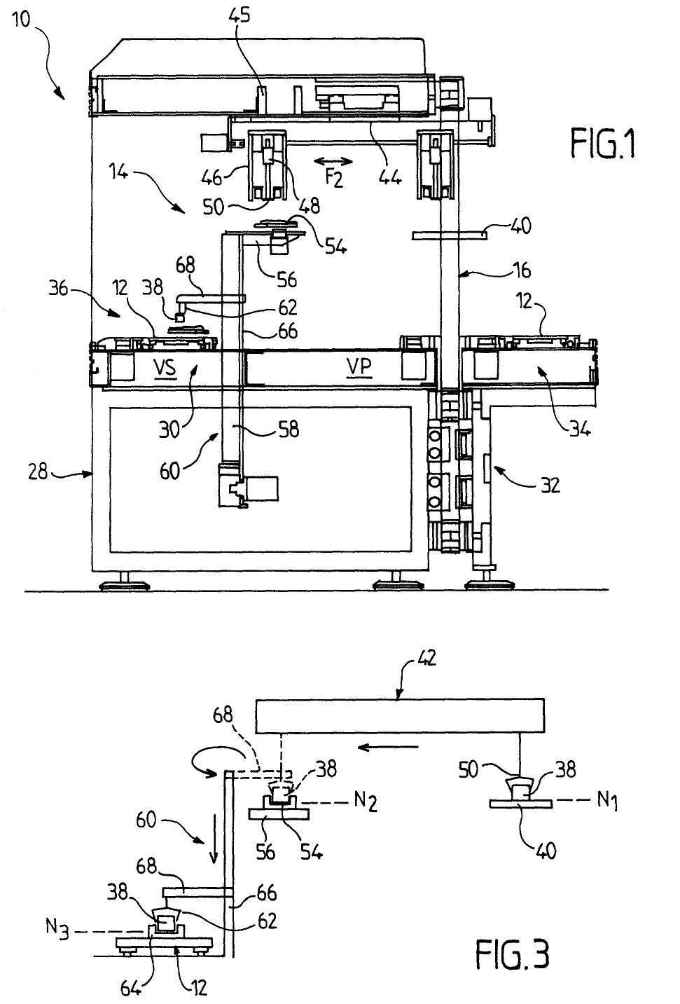

FIG. 1 is an end view of a part of an installation for the circulation of part-carrying pallets, which is provided with a transfer apparatus according to the invention,

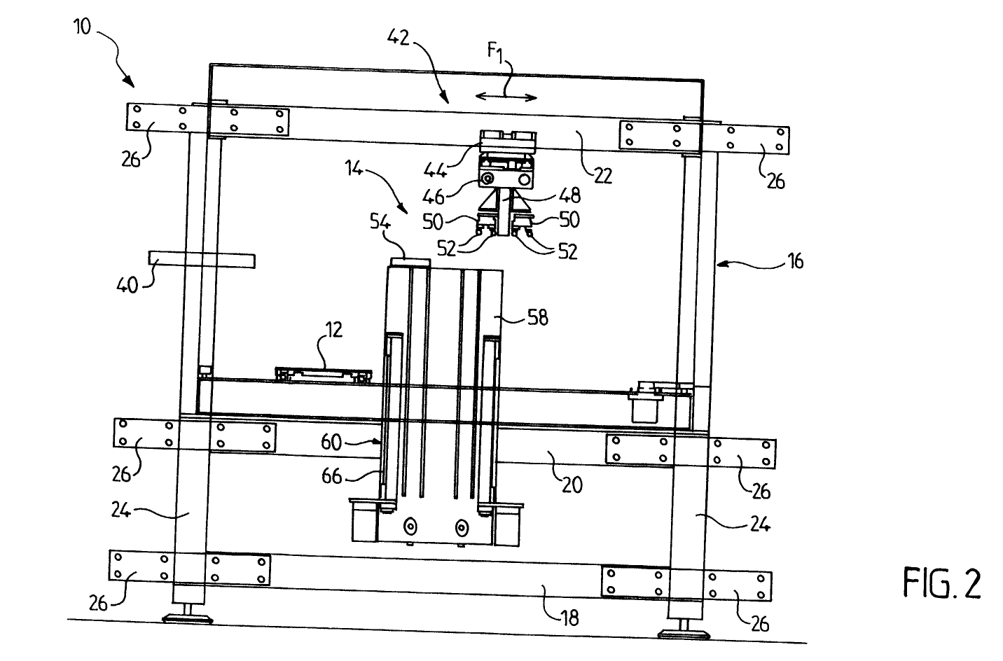

FIG. 2 is a front view of the installation,

FIG. 3 is a diagrammatic representation of the movements implemented by the transfer apparatus of the invention,

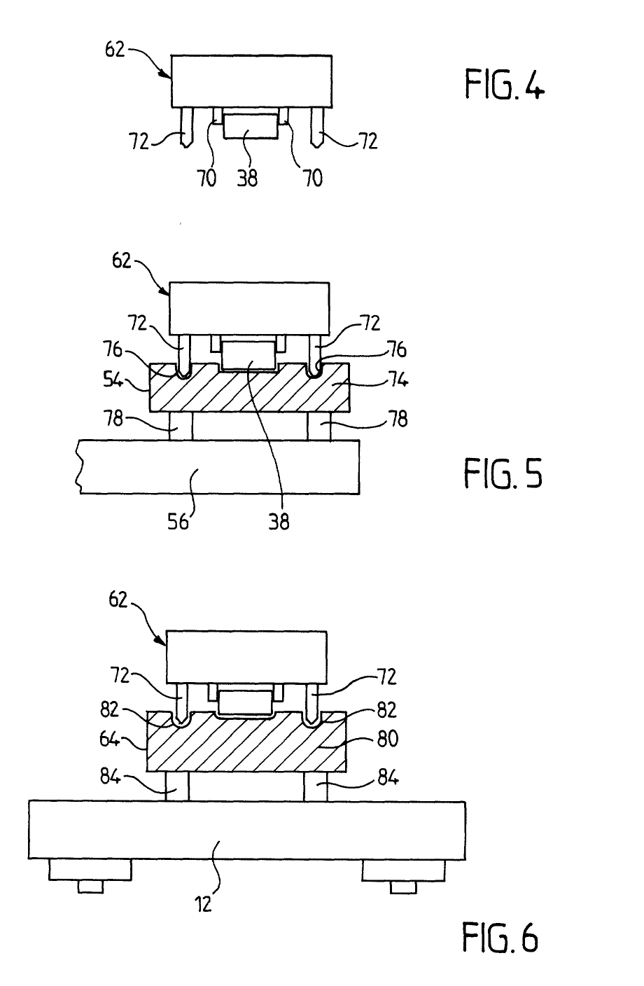

FIG. 4 is an end view of the gripper of the manipulator and its centering means,

FIG. 5 shows the co-operation of the gripper of FIG. 4 with the positioning tool, and

FIG. 6 shows the co-operation of the gripper of FIG. 4 with the positioning receptacle.

Reference is now made jointly to FIGS. 1 and 2 to describe an installation 10 for the circulation of part-carrying pallets 12, which installation is equipped with a transfer apparatus 14 according to the invention.

The installation 10 of which only a part is shown can be of any known type. In the illustrated example it comprises a framework formed by at least one vertical frame 16 of mecano-welded structure, formed by a lower horizontal profile member 18, an intermediate horizontal profile member 20 and an upper horizontal profile member 22, the respective ends of which are fixed to two vertical uprights 24 by way of fixing plates 26 (FIG. 2). Each of those plates extends horizontally, on respective sides of an upright 24, to permit fixing of the frame to another adjoining frame (not shown) to complete the structure of the installation.

In the embodiment illustrated the installation comprises, on respective sides of the vertical frame 16, on the one hand a box 28 of general parallelepipedic shape which supports a module 30 and, on the other hand, a box 32 which supports another module 34 (FIG. 1).

The module 30 defines a horizontal table and permits circulation of a pallet either on a main path VP close to the frame 16 or on a secondary path VS (branch path) which is more remote from the frame 16.

The particular structure of the modules 30 and 34 will not be described in detail as they are not directly part of the invention.

The module 30 permits a pallet 12 either to circulate on the main path VP in a direction perpendicular to the plane of FIG. 1, or to follow a branch path VS in which a pallet can be immobilised at the location of a station 36, for example an assembly station, as shown in FIG. 1.

In contrast, the module 34 affords solely a pure circulation function, that is to say the pallet 12 is displaced perpendicularly to the plane of FIG. 1.

It will be appreciated that the installation in the true sense may be the subject of numerous variations in design and that it may be adapted and comprise different types of modules to permit displacement of the pallets on the modules, being immobilised at the location of assembly and/or machining stations in which the part carried by the pallet can be subjected to particular operations which are either manual or automatic.

In the example the station 36 constitutes an assembly station which permits a part 38 (FIG. 1) to be transferred from a distributor 40 on to the pallet 12 and at a precise position thereon.

The distributor 40 makes it possible to supply the parts which will then be deposited on the pallets 12 by means of the transfer apparatus 14. The supply of parts is effected either manually or preferably automatically. The distributor 40 may in particular be in the form of a conveyor which feeds the parts one by one in a given location in the installation, the supply of the part not necessarily being in a strict position.

When reference is made herein to a part, it must be appreciated that the transfer apparatus 14 can transfer one or more parts at the same time in order to increase the production rates.

Such a transfer apparatus proves an attractive proposition in particular when the situation involves assembling a part, for example a component of a product, which is supplied by the distributor 40, to another part, for example another component of the same product, which is already positioned precisely on the pallet 12.

It will be appreciated that the apparatus is to make it possible to transfer and deposit that first component in an extremely precise position so that it can be fitted to the component which is already present on the pallet.

The apparatus of the invention complies with such requirements and makes it possible to deposit the part 38 in an extremely precise manner, at high operating rates which are compatible with the modern installations in which the pallets are moved at ever increasing speeds.

The structure of the transfer apparatus 14 will now be described with reference to FIGS. 1, 2 and 3.

The apparatus 14 comprises a transporter 42 comprising a mechanism involving crossed movements, formed by a horizontal transverse member 44 forming a movable bridge which is displaceable along the upper profile member 22 and along a profile member 45 which extends parallel to the upper profile member 22.

The transverse member 44 can thus be displaced in parallel relationship with the profile members 22 and 45 in one direction or the other, as shown by the double-headed arrow F1 in FIG. 2.

The transverse member 44 itself carries a carriage 46 which can be displaced horizontally along the transverse member 44 in one direction or the other, as shown by the double-headed arrow F2 in FIG. 1.

Thus the transporter 42 makes it possible to provide for pilot control of the carriage 46 in two mutually perpendicular horizontal directions, as represented by the arrows F1 and F2. The carriage 46 carries a vertical actuator 48, for example a pneumatic ram, which here supports two gripping devices 50, each of which comprises two movable jaws 52 capable of being moved towards each other to grasp a part 38 on the distributor 40 and then being moved away from each other to deposit the part 38.

In an alternative configuration, each of the gripping devices could be designed in another fashion, in particular in the form of a simple suction cup which picks up the part without any precision, the aim of the invention being also to permit a feed of parts in order to deposit them on a pallet with a high degree of precision by virtue of centering means which will be described hereinafter.

The part 38 is here deposited on an intermediate positioning tool 54 forming a cradle for receiving the part and carried by a fixed support 56 which here is in the form of a horizontal bracket in cantilever relationship carried at the upper end of a vertical support 58 which is disposed in line with the assembly station 36. The vertical support 58 extends respectively above and below the module 30. It will be noted that the distributor 40 and the positioning tool 54 are disposed at respective adjoining vertical levels N1 and N2 while the pallet is disposed at a horizontal level N3 below the level N2 of the positioning tool 54 (FIG. 3).

The transporter 42 is pilot-controlled by suitable control means of per se known structure to grasp a part 38 on the distributor 40 and then deposit it in the positioning tool 54, in a position which is not rigorously precise.

The transfer apparatus 14 further comprises a manipulator 60 equipped with a gripper 62 adapted to grasp the part 38 in a precise position on the positioning tool 54, displace it and deposit it in a precise position in a positioning receptacle 64 carried by the pallet 12.

The manipulator 60 comprises an actuator 66 involving vertical displacement, for example of the pillar type, which carries a support arm 68 in the form of a cantilever arm, a first end of which is carried by the actuator 66, and of which one end is carried by the actuator 60 and of which another end carries the gripper 62. The support arm 68 is adapted to pivot over a limited angular range of a selected value which in this example corresponds to 180°, while the vertical-displacement actuator 66 permits the support arm to be displaced vertically between a raised position and a lowered position.

The gripper 62 of the manipulator comprises two movable jaws 70 (FIG. 4) which are capable of being moved towards each other to grasp the part 38 in the positioning tool 54 and to be moved away from each other to deposit the part in the positioning receptacle 64 carried by the pallet. The manipulator 60 is connected to control means which permit the following sequence of operations to be carried out.

The gripper 62 is firstly moved to a position above the positioning tool 54 and then it is actuated to pick up a part 38 in the positioning tool. Then, the support arm is pivoted over a given angular range, in this case 180°, by rotation in a horizontal plane. Then, the support arm is displaced vertically from the raised position to the lowered position by the actuator 66, this permitting the gripper 62 (which holds the part 38) to be moved into a position above the positioning receptacle 64 which is carried by the pallet. Then, the gripper 62 is actuated to move its jaws 70 away from each other and to deposit the part in the positioning receptacle. Those means then permit the gripper to be moved back into a position above the positioning tool 54 for the purposes of a fresh sequence of operations.

The sequences of operations described above are diagrammatically shown in FIG. 3 in which it will be seen that transfer of the part 38 is effected in two successive, mutually co-ordinated phases, the first phase being effected substantially horizontally by means of the transporter 42 with crossed movements, and the second phase being effected by the manipulator 60 by the combination of a horizontal rotational movement and a vertical translatory movement.

Those two means permit the parts to be displaced at high speed. While the manipulator is displacing the part from the positioning tool 54 towards the positioning receptacle 64, the transporter 44 is returning to its initial position to return the gripper 50 to a position above the distributor 40 in order to come to pick up another part 38.

An important feature of the invention lies in the fact that centering means are provided to ensure precise positioning of the gripper 62, on the one hand with the positioning tool 54 and on the other hand with the positioning receptacle 64.

As can be seen from FIG. 4 the gripper 62 comprises male centering rods 72 which are carried by the gripper and which are adapted to co-operate either with the positioning tool 54 (FIG. 5) or with the positioning receptacle 64 (FIG. 6).

The positioning tool 54 comprises a base 74 forming a cradle for receiving the part, in which there are formed holes 76 for receiving the rods 72 of the gripper when the latter is moved towards the positioning tool 54. The rods 72 have a conical or rounded end while the holes 76 are cylindrical and open towards the exterior. They are advantageously flared towards the exterior in order further to facilitate introduction of the rods 72.

Moreover, to facilitate that introduction movement, the base 74 of the positioning tool is mounted floatingly on the fixed support 56 by way of elastic means which are here formed by elastic washers or legs.

In a corresponding fashion the positioning receptacle 64 comprises a base 80 forming a cradle for receiving the part and adapted to the shape thereof. Provided in the base 80 are holes 82 of a flared shape which are intended to facilitate introduction of the rods 72 when the gripper 62 is moved towards the positioning receptacle 64.

As before, the base 80 is fixed to the pallet 12 by elastic means 84 which also comprise elastic washers or legs. The transfer apparatus according to the invention may be the subject of numerous alternative configurations, in particular as regards the structure of the transporter and the structure of the manipulator.

This apparatus may equip different types of installations for the circulation of part-carrying pallets, in which the pallets are displaced in the interior of a module, and from one module to another, either by drive means which are fitted to the module or by motor means which are specific to the pallet.

1. An apparatus for transferring at least one part to be deposited on an immobilised pallet, characterised in that it comprises a transporter (42) equipped with a gripping device (50) and adapted to grasp the part (38) on a distributor (40), displace it and deposit it in a positioning tool (54), and a manipulator (60) equipped with a gripper (62) and adapted to grasp the part in a precise position in the positioning tool (54), displace it and deposit it in a precise position in a positioning receptacle (64) carried by the pallet (12).

2. An apparatus as set forth in claim 1 characterised in that the distributor (40) and the positioning tool (54) are disposed at adjacent vertical levels (N1, N2) while the positioning receptacle (64) carried by the pallet is disposed at a vertical level (N3) below the vertical level (N2) of the positioning tool (54).

3. An apparatus as set forth in one of claims 1 and 2 characterised in that transporter (42) comprises a mechanism (22, 45, 44) involving crossed movements, which is adapted to provide pilot-control of a carriage (46) in two mutually perpendicular horizontal directions (F1, F2), and the carriage (46) carries a vertical actuator (48) which supports the gripping device (50).

4. An apparatus as set forth in one of claims 1 through 3 characterised in that the gripper (50) comprises two movable jaws (52) adapted to be moved towards each other to grasp the part (38) on the distributor (40) and to be moved away from each other to deposit it in the positioning tool (64).

5. An apparatus as set forth in one of claims 1 through 4 characterised in that the manipulator (60) comprises an actuator (66) involving vertical displacement, which carries a support arm (68) adapted to pivot over a limited angular range of selected value, and the support arm (68) supports the gripper (62) to permit the latter to be displaced by a combined movement of horizontal rotation and vertical translation.

6. Apparatus as set forth in claim 5 characterised in that the manipulator (60) is connected to operational control means for effecting the following sequence of operations: moving the gripper (62) above the positioning tool (54), actuating the gripper (62) to pick up the part (38) in said positioning tool (54), pivoting the support arm (68) over said angular range, displacing the support arm (68) vertically without a change to its angular orientation to move the gripper (62) above the positioning receptacle (64) carried by the pallet, actuating the gripper (62) to deposit the part in said positioning receptacle (64) and moving the gripper again above the positioning tool (54) for a fresh sequence of operations.

7. Apparatus as set forth in one of claims 5 and 6 characterised in that said limited angular range corresponds to 180°.

8. Apparatus as set forth in one of claims 5 through 7 characterised in that the gripper (62) comprises two movable jaws (70) adapted to be moved towards each other to grasp the part (38) in the positioning tool (54) and to be moved away from each other to deposit it in the positioning receptacle (64) carried by the pallet (12).

9. Apparatus as set forth in one of claims 5 through 8 characterised in that it comprises centering means (72, 76, 82) adapted to effect precise mutual positioning of the gripper (62) on the one hand with the positioning tool (54) and on the other hand with the positioning receptacle (64) carried by the pallet.

10. Apparatus as set forth in claim 9 characterised in that the centering means comprise at least two male centering rods (72) carried by the gripper (62) and adapted to engage either into corresponding holes (76) in the positioning tool (54) or into corresponding holes (82) in the positioning receptacle (64) carried by the pallet.

11. Apparatus as set forth in claim 10 characterised in that the positioning tool (54) is mounted floatingly on a fixed support (56) by way of elastic means (78).

12. Apparatus as set forth in claim 10 characterised in that the positioning receptacle (64) is mounted floatingly on the pallet (12) by way of elastic means (84).

13. Apparatus as set forth in one of claims 11 and 12 characterised in that the elastic means (78, 84) comprise elastic washers or legs.

14. An installation for the circulation of part-carrying pallets characterised in that it comprises a transfer apparatus (14) according to one of claims 1 through 13 arranged to deposit a part (38) on a pallet (12) immobilised at the location of a station (36) of the installation.
